(19) United States
(12) Patent Application Publication
(10) Pub. No.: US 2018/0309622 A1
(43) Pub. Date: Oct. 25, 2018

(54) SYSTEM AND METHOD FOR GENERATING AN ALERT ASSOCIATED WITH A DEVICE CONSUMING A RESOURCE

(71) Applicant: HCL Technologies Italy S.p.A., Vimodrone (IT)

(72) Inventors: Gorga Ilaria, Roma (IT); Pizzutillo Riccardo, Roma (IT); Presti Luigi, Roma (IT); Longobardi Giuseppe, Roma (IT)

(21) Appl. No.: 15/496,453

(22) Filed: Apr. 25, 2017

(51) Int. Cl. H04L 12/24; H04L 12/911

(52) U.S. Cl. CPC H04L 41/0681; H04L 67/12; H04L 41/0686; H04L 47/743

(57) ABSTRACT

Disclosed is a system for generating an alert associated with a device consuming a resource. A data receiving module receives the alert from the device of a first set of devices. The identification module identifies similar type devices from the first set of devices. The data receiving module receives a first response whether the resource is available to the similar type devices from the similar type devices. When the first response indicates unavailability of the resource, the data receiving module receives a second response regarding the unavailability of the resource from one or more of a second set of devices. An alert generation module generates an alert to an owner of the device when the resource is available to the similar type devices and to a resource supplier of the resource when the resource is unavailable to the premises and one or more other premises.

### TECHNICAL FIELD

The present subject matter described herein, in general, relates to Internet of Things (IoTs) and in particularly to a system and method for generating an alert associated with a device consuming a resource.

### BACKGROUND

In today's era, the Internet, along with Internet of Things (IoT) devices, facilitates to establish a network of physical devices, machines, tools, appliances and others, with each other. A smart appliance is one of such example of an emerging Internet of Things (IoTs) space where smart appliance can be driven remotely. It may be understood that the smart appliance may consume a plurality of resources such as water, gas, electricity and others. Even after the presence of the IoT devices, it becomes cumbersome to ensure whether a fault is in a smart appliance or with a supply of at least one resource.

### SUMMARY

Before the present systems and methods for generating an alert associated with a device consuming a resource, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for generating an alert associated with a device consuming a resource. This summary is not intended to identify essential features of the claimed subject matter nor is it intended for use in determining or limiting the scope of the claimed subject matter.

In one implementation, a method for generating an alert associated with a device consuming a resource is disclosed. In order to generate the alert, an alert may be received from a device of a first set of devices present in a premises. In one aspect, the alert may be associated to an event associated with at least one of the device and a resource of a plurality of resources. Once the alert is received, similar type devices may be identified from the first set of devices. Upon identifying the similar type devices, a first response may be received from the similar type devices whether the resource is available to the similar type devices. When the first response indicates unavailability of the resource to the similar type devices, a second response may be received regarding the unavailability of the resource from one or more of a second set of devices present in another premises. In one embodiment, when the first response indicates the availability of the resource to the similar type devices, an alert may be generated to at least one owner of the device. In another embodiment, when the second response indicates the unavailability of the resource to the second set of devices, an alert may be generated to a resource supplier of the resource.

In another implementation, a system for generating an alert associated with a device consuming a resource is disclosed. The system may comprise a processor and a memory coupled to the processor. The processor may execute a plurality of modules present in the memory. The plurality of modules may comprise a data receiving module, an identification module, and an alert generation module. The data receiving module may receive an alert from a device of a first set of devices present in a premises. In one aspect, the alert may be associated to an event associated with at least one of the device and a resource of a plurality of resources. The identification module may identify similar type devices from the first set of devices. Further to identification of the similar type devices, the data receiving module may receive a first response from the similar type devices whether the resource is available to the similar type devices. When the first response indicates unavailability of the resource to the similar type devices the data receiving module may receive a second response regarding the unavailability of the resource from one or more of a second set of devices present in another premises. In one embodiment, when the first response indicates the availability of the resource to the similar type devices, an alert generation module may generate an alert to at least one owner of the device. In another embodiment, when the second response indicates the unavailability of the resource to the second set of devices, the alert generation module may generate an alert to a resource supplier of the resource.

In yet another implementation, non-transitory computer readable medium embodying a program executable in a computing device for generating an alert associated with a device consuming a resource is disclosed. The program may comprise a program code for receiving an alert from a device of a first set of devices, present in a premises. In one aspect, the alert may be associated to an event associated with at least one of the device and a resource of a plurality of resources. The program may further comprise a program code for identifying similar type devices from the first set of devices. The program may further comprise a program code for receiving a first response from the similar type devices whether the resource is available to the similar type devices. When the first response indicates unavailability of the resource to the similar type devices, the program may comprise a program code for receiving a second response regarding the unavailability of the resource from one or more of a second set of devices present in another premises. In one embodiment, when the first response indicates the availability of the resource to the similar type devices, the program may comprise a program code for generating an alert to at least one owner of the device. In another embodiment, when the second response indicates the unavailability of the resource to the second set of devices, the program may comprise a program code for generating an alert to a resource supplier of the resource.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for generating an alert associated with a device consuming a resource, in accordance with an embodiment of the present subject matter.

FIG. 2 illustrates the system, in accordance with an embodiment of the present subject matter.

FIG. 3 illustrates a method for generating the alert associated with the device consuming the resource, in accordance with an embodiment of the present subject matter.

### DETAILED DESCRIPTION

Some embodiments of the present disclosure, illustrating all its features, will now be discussed in detail. The words “receiving,” “identifying,” “generating,” and “computing” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods for generating an alert associated with a device consuming a resource are now described. The disclosed embodiments of the system and method for generating an alert associated with a device consuming a resource are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure for generating an alert associated with a device consuming a resource is not intended to be limited to the embodiments illustrated, but is to be accorded the widest scope consistent with the principles and features described herein.

A system and method for generating an alert associated with a device, of one or more devices, consuming a resource is disclosed. Examples of the device may be any smart appliance including, but not limited to, a refrigerator, a dishwasher, a dryer, an oven, a water purifier, a washing machine, and others. It may be understood that the one or more devices may be embedded with sensors, data aggregators, and IoT based devices. Examples of the resource may include, but not limited to, water, gas, electricity, and others. Prior to generating the alert, a network may be established between one or more devices, a device manager, a network owner, a social server, and a resource supplier. In one embodiment, the device manager may be communicatively coupled to the one or more devices, present in a premises, and the social server. In one aspect, the device manager may be configured to perform at least one operation including, but not limited to, managing, controlling, and notifying the alert to the owner of the device. The social server, on the other hand, may be configured to perform at least one of receiving the alert and generating the alert. In one aspect, the alert may be received from at least one of the one or more devices and the device manager. On the other hand, the alert may be generated for at least one of the owner of the device and the resource supplier.

The network owner may be communicatively coupled to a set of the device manager and the social server. It may be understood that the network owner is capable of managing the set of the device manager present in the premises. Further, the resource supplier may be communicatively coupled to at least one of the device manager, the network owner, and the social server. In one aspect, the resource supplier may be configured to manage operations pertaining to the supply of a resource of the plurality of resources. Examples of the operations may include, but not limited to, broadcasting message indicating a cause of a fault in supply of the resource and a downtime in supply of the resource.

After establishing the network, the alert associated with the device consuming the resource may be generated. In order to generate the alert, initially, an alert may be received from the device present in a premises. Once the alert is received, a local investigation may be initiated in the premises for determining other devices, of the first set of device, consuming same resource. Upon determination of the other devices consuming the same resource, supply of the resource may be verified in the premises. In one embodiment, when the local investigation indicates availability of the resource to the other devices, the alert may be generated to at least an owner of the device. The alert, here, indicates a fault in the device. In another embodiment, when the local investigation indicates unavailability of the resource, a global investigation may be initiated in one or more other premises neighboring to the premises in order to determine availability of the resource in the one or more other premises. Upon initiating the global investigation, each other device manager, corresponding to each other premises, may initiate the local investigation in their respective premises.

Based on the global investigation, if another device manager also reports unavailability of the resource at the other premises, a resource supplier of the resource may be notified regarding unavailability of the supply to the premises and the one or more other premises. Further to notifying the resource supplier, the resource supplier may identify an area impacted due to the unavailability of the resource. Upon identifying the area impacted, the resource supplier may perform at least one operations i.e. broadcasting a message indicating a cause of a fault in supply of the resource, a downtime in supply of the resource.

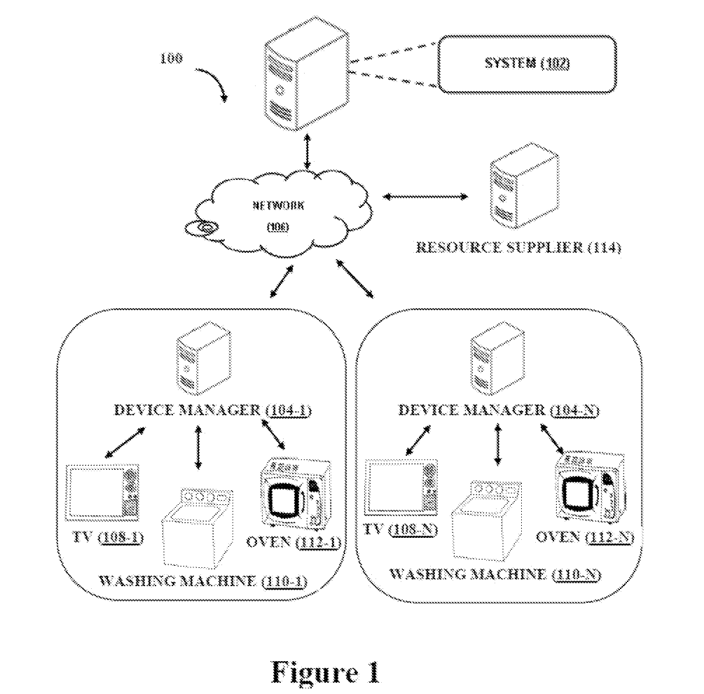

Referring to FIG. 1, a network implementation 100 of a system 102 for generating an alert associated with a device consuming a resource is disclosed. In order to generate the alert associated with the device consuming the resource, initially, the system 102 receives an alert from a device of a first set of devices present in a premises. In one aspect, the alert may be associated to an event associated with at least one of the device and a resource of a plurality of resources. Once the alert is received, the system 102 identifies similar type devices from the first set of devices. Upon identifying the similar type devices, the system 102 receives a first response from the similar type devices whether the resource is available to the similar type devices. When the first response indicates unavailability of the resource to the similar type devices, the system 102 receives a second response from one or more of a second set of devices, present in another premises, regarding the unavailability of the resource. In one embodiment, when the first response indicates the availability of the resource to the similar type devices, the system 102 generates an alert to at least one owner of the device. In another embodiment, when the second response indicates the unavailability of the resource to the second set of devices, the system 102 generates an alert to a resource supplier of the resource.

Although the present disclosure is explained considering that the system 102 is implemented on a social server, it may be understood that the system 102 may be implemented in a variety of computing systems, such as a laptop computer, a desktop computer, a notebook, a workstation, a mainframe computer, a server, a network server, a cloud-based computing environment. It may be understood that the system 102 may also be implemented on the device manager. When the system 102 is implemented on the social server, each device manager, of a premises, may be communicatively coupled with another device manager via the social server. On the other hand, when the system 102 is implemented on the device manager 114, each device manager, present in the premises, may be directly communicatively coupled with another device manager, present in another premises. It may further be understood that each device manager is configured to manage operations of one or more devices. Examples of the one or more device may include, but not limited to, Television (TV) 108-1, 108-2, . . . 108-N (hereinafter referred as TV 108), a washing machine 110-1, 110-2, . . . 110-N (hereinafter referred as washing machine 110), an oven 112-1, 112-2, . . . 112-N (hereinafter referred as oven 112), and the like. In one implementation, the system 102 may comprise the cloud-based computing environment in which a user may operate individual computing systems configured to execute remotely located applications via a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

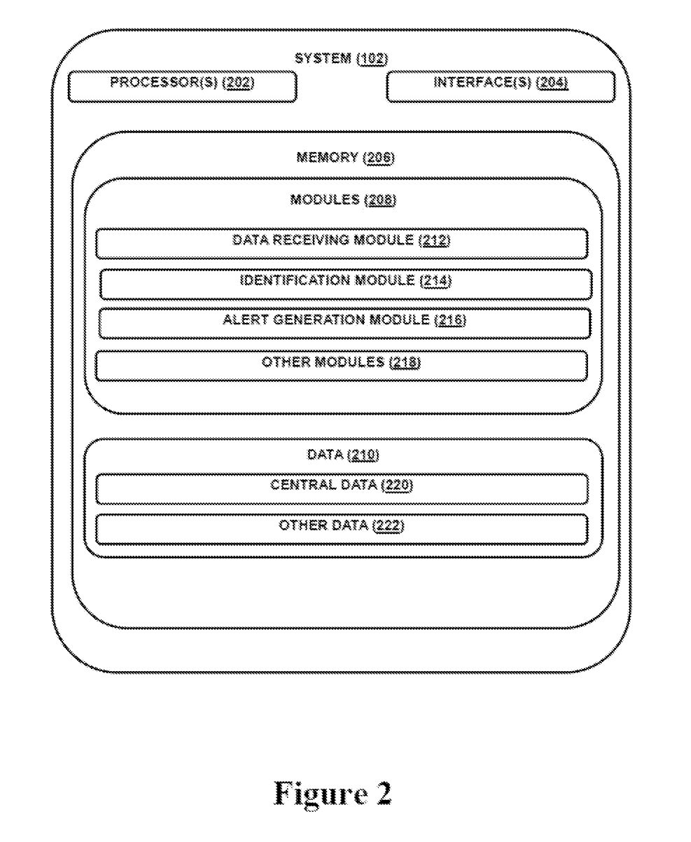

Referring now to FIG. 2, the system 102 is illustrated in accordance with an embodiment for generating an alert associated with a device consuming a resource. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, cloud storages and magnetic tapes. The memory 206 may include modules 208 and data 210.

The modules 208 include routines, programs, objects, components, data structures, etc., which perform particular tasks or implement particular abstract data types. In one implementation, the modules 208 may include a data receiving module 212, an identification module 214, and an alert generation module 216, and other modules 218. The other modules 218 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208 of the system 102 for generating an alert associated with a device consuming a resource. The data 210 may also include a central data 220, and other data 222. The other data 222 may include data generated as a result of the execution of one or more modules in the other modules 218.

In one embodiment, the user may use the client device (not shown in figure) to access the system 102 via the I/O interface 204. Example of the client device may comprise a mobile phone, a tablet phone, a laptop and others. Further, the user may register using the I/O interface 204 in order to use the system 102. In one aspect, the user may access the I/O interface 204 of the system 102. The system 102 may employ the data receiving module 212, the identification module 214, and the alert generation module 216. The detail functioning of the modules is described below with the help of FIG. 2.

Referring again to FIG. 2, initially, the data receiving module 212 may register the device, in the premises, by generating a unique identification number. The unique identification number may be based on device name, type of resource consumed, the premises of the device, location of the device, and others. In one example, the unique identification number may be an alphanumeric number, a model number of the device, a device name, a combination of model and home number, and others. Upon receiving the alert, the data receiving module 212 may also receive the location of the device, the home number, an address, information related to at least one owner, and others.

Further to registering the device, the data receiving module 212 receives an alert from a device of a first set of devices, present in a premises. In one example, the alert is associated to an event associated with at least one of the device and a resource of a plurality of resources. Examples of the device may be a refrigerator, a dishwasher, a dryer, a TV 108, a washing machine 110, an oven 112, a water purifier, and others. It may be understood that the device may be embedded with at least a sensor, a data aggregator, a Network Interface Card (NIC), IoT based devices, and IoT based sensors. Examples of the event may include, but not limited to, malfunctioning of the device, issue related to booting of the device, unavailability of the resource. Examples of the premises may include, but not limited to, a home, an office, an apartment, a society, a town, a city, a district.

Further to receiving the alert from the device, of the first set of devices, present in the premises, the identification module 214 identifies similar type devices from the first set of devices. The similar type devices may be identified based on a consumption of identical resource, of the plurality of resources. Examples of the resource may include, but not limited to, comprising water, gas, electricity and others. In one aspect, the identification module 214 may identify the refrigerator, the dishwasher, and the washing machine 110 as the similar type devices, because the resource consumed by the refrigerator, the dishwasher, and the washing machine 110 is both the electricity and the water. Similarly, the identification module 214 may identify the TV and the oven as the similar type devices, because the resource consumed by the TV and the oven is electricity. In one embodiment, the identification module 214 may identify similar type devices from the first set of devices connected to the device manager.

Further to identifying the similar type devices from the first set of devices, the data receiving module 212 receives a first response from the similar type devices whether the resource is available to the similar type devices. In one embodiment, when the first response indicates unavailability of the resource to the similar type devices, the data receiving module 212 may receive a second response from one or more of a second set of devices, present in the other premises, regarding the unavailability of the resource. In one example, the data receiving module 212 may receive the first response regarding availability of the electricity and the water from the refrigerator, the dishwasher, and the washing machine 110. When the first response indicates unavailability of at least the water and the electricity to the refrigerator, the dishwasher, and the washing machine 110, the data receiving module 212 may receive the second response regarding the unavailability of at least the water and the electricity from the one or more of the refrigerator, the dishwasher, and the washing machine 110 present in the other premises.

Further to identifying the similar type devices from the first set of devices, the data receiving module 212 may receive the first response from the similar type devices, connected to the device manager 104 of the premises. In one embodiment, when the first response indicates unavailability of the resource to the similar type devices connected to the device manager 104, the data receiving module 212 may receive the second response from the second set of devices connected to the peer device manager 104 present in the other premises.

In another embodiment, further to receiving the first response from the similar type devices connected to the device manager 104, the data receiving module 212 may compute a confidence index, associated with the device manager 104, based on the unavailability of the resource to one or more of the similar type devices and a total number of the similar type devices. The confidence index may be computed as below

$$Confidence Index = \frac{TNDA}{TNDR} \qquad Equation ( 1 )$$

As described in above equation (1), the data receiving module 212 computes “Confidence Index” based on “TNDA” and “TNDR.” In one aspect, the “TNDA” indicates “Total Number of Devices generating Alert regarding unavailability of the resource”, and “TNDR” indicates “Total Number of Devices consuming the Resource.” It may be understood that the confidence index indicates a probability score corresponding to the unavailability of the resource amongst the set of devices, present in the premises.

In one example, when the confidence index is less than a predefined threshold, the identification module 214 may identify a fault in the device. In another example, when the confidence index is higher than the predefined threshold, the identification module 214 may identify the fault in the supply of the resource to the premises and the one or more other premises. In yet another example, when the confidence index is close to 0, the confidence index may be termed as low and when the confidence index is close to 1, the confidence index may be termed as high. Further to identifying the fault in the supply of the resource, the data receiving module 212 may compute the confidence index associated with the peer device manager of the other premises.

In one embodiment, subsequent to receiving of the first response, when the first response indicates the availability of the resource to the similar type devices, the alert generation module 216 may generate an alert to at least one owner of the device. Further, the alert generation module 216 may transmit the alert in the form of an email, a message, a push notification, a pager, a social media feed and the like. In another embodiment, further to receiving the second response, when the second response indicates the unavailability of the resource to the second set of devices, the alert generation module 216 may generate an alert to a resource supplier 114 of the resource regarding unavailability of the supply to the premises and the one or more other premises. Upon generating the alert to the resource supplier, the alert generation module 216 may receive a message comprising a cause of the unavailability of the resource and the downtime in supply of the resource. Subsequent to receiving the message, the alert generation module 216 may broadcast the message to the at least one owner of the device impacted by the fault. In one aspect, the alert generation module 216 may transmit the alert to at least a call center, a service station and others present in the premises and the one or more other premises.

In one embodiment, when the confidence index associated with the device manager may be lesser than a predefined threshold, the alert generation module 216 may generate an alert to the at least one owner of the device regarding a fault in the device. In another embodiment, when the confidence index associated with the peer device manager may be higher than the predefined threshold, the alert generation module 216 may generate an alert to the resource supplier 114 of the resource regarding the fault in the supply to the premises and the one or more other premises.

In yet another embodiment, when another device manager 104, present in the location of the resource supplier 114, generates the alert regarding unavailability of the resource, initially, the data receiving module 212 may examine whether the unavailability of the resource in the location has already been reported. If the unavailability of the resource has already been reported, the alert generation module 216 may broadcast the message indicating the cause of the fault in supply of the resource and the downtime in supply of the resource, to the at least one owner of the device thereby preventing data flooding in the network.

In order to explain the functioning of the aforementioned modules, consider an example where “John” intends to throw a party, at home, for his friends, “Joshua,” “Jenny,” and family members. The home of “John” comprises a set of devices including, but not limited to, the refrigerator, the TV 108, the washing machine 110, the oven 112, the air conditioner, the water purifier, the dish washer and the like. Initially, the data receiving module 212 may register the set of devices by generating a unique identification number based on a device name, a type of resource consumed, a premises of the device, and others. It may be understood that the device may embedded with at least a sensor, a data aggregator, a NIC, and IoT based devices. Now, during operation, the data receiving module 212 may receive an alert from the dish washer because of an incomplete operation of the dishwasher. Further to receiving the alert, the identification module 214 may identify the similar type devices from the set of devices operating in the home. Examples of the similar type devices may be the washing machine 110 and the water purifier as both the devices consume the electricity and the water as resource. Further to identifying the similar type devices, the data receiving module 212 may receive a first response from the washing machine 110 and the water purifier regarding availability of the water. When the first response indicates unavailability of the water to both the washing machine 110 and the water purifier, the data receiving module 212 may receive a second response from one or more of a second set of devices, present in another premises, regarding the unavailability of the water. In one embodiment, the identification module 214 may identify the other premises based on social references, social media contacts, location of home, of “John.” Hence the home of “Joshua” and “Jenny” may be identified as the other premises. Upon identifying the other premises, the data receiving module 212 may receive a second response from the one or more devices consuming the water, installed in the home of “Joshua” and “Jenny.” When the second response indicates the unavailability of the water, it may be understood that the premises is impacted by a fault in a supply of the water. Further to identifying fault in the supply of the water, above mentioned steps may be repeated recursively for investigating the availability of the water in some other premises. It may be understood that the identification of some other premises may be based on social references, the location of the home, and the social media contacts, of “John,” “Joshua,” and “Jenny.”

Further to receiving the second response indicating the unavailability of the water, the alert generation module 216 may generate an alert to a water supply authority in the premises of the device. Upon generating the alert, the alert generation module 216 may receive a message from the water supply authority indicating a cause of the fault in the supply of the water to the premises and the downtime in the supply of the water. Upon receiving the message, the alert generation module 216 may broadcast the message to “John,” “Joshua,” “Jenny” and other owners impacted by the fault in the supply of the water.

In another example, when the first response indicates an availability of both the electricity and the water to the washing machine 110 and the water purifier, the alert generation module 216 may generate an alert to “John” and the family members, indicating the fault in the dishwasher. Furthermore, the alert generation module 216 may also generate the alert to at least a service center, and a call center to fix the fault in the dishwasher.

In one embodiment, the set of devices, present in the home of “John” may be communicatively coupled to a device manager 104. Similarly, the set of devices present in the home of “Joshua,” “Jenny” and others may be communicatively coupled to at least one peer device manager 104. It may be understood that the device manager 104 may be configured to manage operations of the set of devices and is communicatively coupled to at least a social server, the resource supplier 114 and a peer device manager 104.

In another example, upon receiving the first response, regarding unavailability of the water, from the set of devices, the data receiving module 212 may compute the confidence index corresponding to the set of devices present in the home of “John.” As per equation (1), “TNDA” indicates “Total Number of Devices generating Alert regarding unavailability of the resource” and is equal to 3 comprising the dishwasher, the washing machine 110 and the water purifier. “TNDR” indicates “Total Number of Devices consuming the Resource” and is equal to 3 as comprising only the dishwasher, the washing machine 110 and the water purifier. Hence CI for the first set of device is 1 and hence termed as high. Upon computing the CI equals to 1, the data receiving module 212 may further compute the CI for the one or more of the second set of devices, present in the home of “Joshua” and “Jenny.” When the CI for the one or more of the second set of devices is also computed high, the alert generation module 216 may generate the alert to the water supply authority regarding unavailability of the supply of water in the premises of “John,” “Joshua” and “Jenny.”

In yet another example, when the first response indicates the availability of the water to the washing machine 110 and the water purifier, “TNDA” may be 1 and the “TNDR” may be 3. Furthermore, as per equation (1), the data receiving module 212 may compute the confidence index as 0.33 and hence may be termed as low. It may be evident from the low confidence index that the fault is in the dishwasher and not in the supply of the water. Subsequently, alert generation module 216 may generate the alert to “John” and the family members, indicating the fault in the dishwasher.

In one embodiment, the confidence index may also be computed for the device manager 104, and the network owners. In one example, consider a network owner comprising 10 device managers which are further connected to 150 devices each. And one of device consuming water and electricity has generated an alert. In addition, only 100 devices out of 150 devices consume water and all the 150 devices consume electricity. Furthermore, a local investigation reports a fault in 80 devices connected to a local device manager and the global investigation reports the fault in 9 device managers connected to the network owner. As per the equation (1), CI may be computed based on TNDA and TNDR.

As per the above information, TNDA=80.

TNDR=(total devices consuming electricity and water)−(total devices not consuming water)=150−50=100. Hence TNDR=100.

Now as per the equation (1),

$$Confidence Index = \frac{TNDA}{TNDR}$$

$$Confidence Index = \frac{80}{100} = 0.8$$

As the Confidence Index corresponding to the device manager is close to 1, a fault in the supply of the water may be identified and hence the data receiving module 212 may request the network owner to initiate global investigation amongst the peer device manager.

In one embodiment, the confidence index may also be computed for the network owner based on total number of device managers reporting the alert and the total number of device managers connected to the network owner. Hence the equation (1) may be updated as below

$$Confidence Index corresponding to a network owner = \frac{TNDA}{TNDR} \qquad Equation ( 2 )$$

As per the equation (2), the “TNDA” indicates “Total Number of Device managers generating Alert regarding unavailability of the resource” and the “TNDR” indicates “Total Number of Devices managers connected to the device consuming the Resource.”

Hence as per the equation (2), considering again the above example,

TNDA=9, TNDR=10

$$Hence Confidence Index corresponding to a network owner = \frac{9}{10} = 0.9$$

As the Confidence Index corresponding to the network owner is close to 1, a fault in the location of the network area may be identified and an alert may be generated to a water supply authority, in the location, regarding the unavailability of the water.

Similarly, when the confidence index corresponding to the network owner or the device manager is close to 0, an alert may be generated to at least one owner of the device.

In one example, the alert generation module 216 may provide recommendation to at least the owner, call center, the resource supplier and others, regarding the fault in the device or the supply of the resource to the premises. In another example, the alert generation module 216 may transmit the recommendation via an email, a text message, a call, a pager and others.

In one example, the alert associated with the device consuming the resource may be referred by at least government authorities, call centers, service stations, and owners of the device to monitor operation of the device. In one aspect, the government authorities, prior to receiving the alert from the devices, may warn the owner of the device regarding the downtime in the supply of the resource. In other aspect, the call centers, the service stations and others may transmit an automated action plan to the owner of the device regarding the fault occurred in the device.

In one example, the aforementioned system may provide real time alerts about the unavailability of the resource to at least one owner of the device, a call center, a service station, the resource supplier, and others.

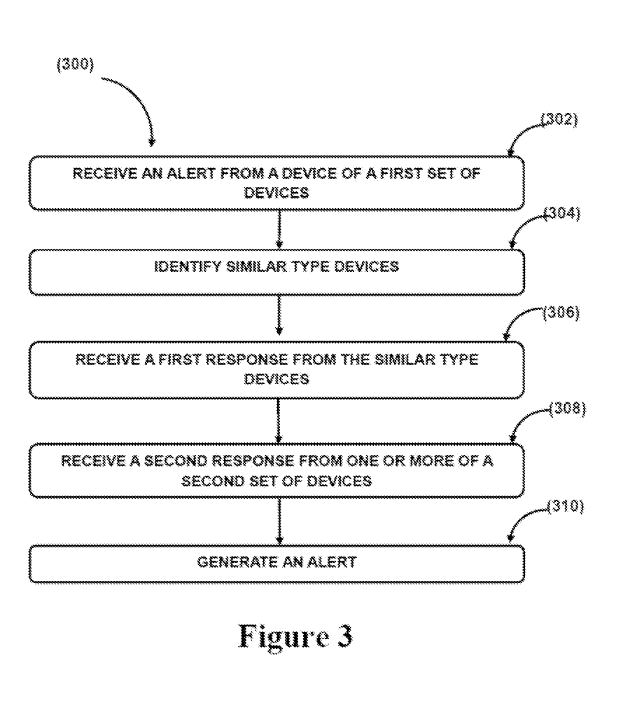

Referring now to FIG. 3, a method 300 for generating an alert associated with a device consuming a resource is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented as described in the system 102.

At block 302, an alert from a device of a first set of devices may be received. In one example, the alert is associated to an event associated with at least one of the device and a resource of a plurality of resources. In one implementation, the data receiving module 212 may receive an alert from the device of a first set of devices, present in a premises, and store a location of the device, a home number, an address, an information related to at least one owner in the central data 220.

At block 304, similar type devices may be identified. In one example, the similar type devices may be identified based on a consumption of identical resource of the plurality of resources. Examples of the resource may be water, gas, electricity and others. In one implementation, the identification module 214 may identify the similar type devices from the first set of devices and stores the unique identification number associated with the device in the central data 220.

At block 306, a first response from the similar type devices is received. In one implementation, the data receiving module 212 receives a first response from the similar type devices whether the resource is available to the similar type devices and stores the first response in the central data 220.

At block 308, a second response from one or more of a second set of devices, present in other premises, is received. In one embodiment, when the first response indicates unavailability of the resource to the similar type devices, the data receiving module 212 may receive a second response from one or more of a second set of devices, present in the other premises, regarding the unavailability of the resource and stores the second response in the central data 220.

At block 310, an alert is generated. In one embodiment, when the first response indicates the availability of the resource to the similar type devices, the alert generation module 216 may generate an alert to at least one owner of the device. In another embodiment, when the second response indicates the unavailability of the resource to the second set of devices, the alert generation module 216 may generate an alert to a resource supplier of the resource and stores a message received from the resource supplier in the central data 220.

Exemplary embodiments discussed above may provide certain advantages. Though not required to practice aspects of the disclosure, these advantages may include those provided by the following features.

Some embodiments enable a system and a method to monitor health of the devices present in a premises.

Some embodiments enable a system and a method to trigger the fault in the supply of the resource.

Some embodiments enable a system and a method to evaluate impacted area of the fault in a social references and in a hierarchical structure of device manager, network owner, social server and so on.

Some embodiments enable a system and a method to propose an action plan to at least one owner regarding the alert generated by the device.

Some embodiments enable a system and a method to categorize devices based on the consumption of the resource.

Some embodiments enable a system and a method to notify at least one owner and the service center to repair the fault in the device via a text message, a multimedia message, email, and the like.

Some embodiments enable a system and a method to investigate the supply of the resource based on the social media references, social media contact list, home location and others.

Some embodiments enable a system and a method to monitor fluctuation or change in the supply of the resource based on the confidence index.

Some embodiments enable a system and a method to assist the resource supplier in identifying geographical area impacted by the fault.

Although implementations for methods and systems for generating an alert associated with a device consuming a resource have been described in language specific to structural features and/or methods, it is to be understood that the appended claims are not necessarily limited to the specific features or methods described. Rather, the specific features and methods are disclosed as examples of implementations for generating an alert associated with a device consuming a resource.

We claim:

1. A method for generating an alert associated with a device consuming a resource of a plurality of resources, the method comprising:
receiving, by a processor, an alert from the device of a first set of devices, present on a premises, wherein the alert is associated with an event regarding at least one of the device and the resource of the plurality of resources;
identifying, by the processor, similar type devices from the first set of devices;
receiving, by the processor, a first response from the similar type devices, the first response indicating whether the resource is available to the similar type devices;
receiving, by the processor, a second response from a second set of devices, present in another premises, the second response indicating an unavailability of the resource when the first response indicates an unavailability of the resource to the similar type devices; and
generating, by the processor, an alert to:
at least one user of the device when the first response indicates the availability of the resource to the similar type devices, and
a resource supplier of the resource when the second response indicates the unavailability of the resource to the second set of devices.

2. The method of claim 1, wherein the similar type devices are identified based on a consumption of an identical resource of the plurality of resources.

3. The method of claim 1 further comprises receiving a message, from the resource supplier, by the at least one user of the device, wherein the message comprises a cause of the unavailability of the resource and a time to resolve.

4. The method of claim 1, wherein the first set of devices, present in the premises, is communicatively coupled to a device manager, and wherein the second set of devices is communicatively coupled to a peer device manager, and wherein the device manager and the peer device manager are configured to manage operations of the first set of devices and the second set of devices respectively.

5. The method of claim 1, wherein the device comprises a sensor, a data aggregator, Internet of Thing (IoT) based devices, IoT based sensors and a Network Interface Card (NIC).

6. The method of claim 4, further comprising computing a confidence index for at least one device manager based on the unavailability of the resource to one or more of the similar type devices and a total number of the similar type devices, wherein the confidence index indicates a probability score corresponding to the unavailability of the resource.

7. A system for generating an alert associated with a device consuming a resource of a plurality of resources, the system comprising:
a memory; and
a processor coupled to the memory, wherein the processor is capable of executing a plurality of modules stored in the memory, and wherein the plurality of modules comprises:
a data receiving module configured to receive an alert from the device of a first set of devices, present on a premises, wherein the alert is associated with an event regarding at least one of the device and the resource of the plurality of resources;
an identification module configured to identify similar type devices from the first set of devices,
wherein the data receiving module further receives:
a first response from the similar type devices, the first response indicating whether the resource is available to the similar type devices, and
a second response from a second set of devices, present in another premises, the second response indicating an unavailability of the resource when the first response indicates an unavailability of the resource to the similar type devices; and
an alert generation module configured to generate an alert to:
at least one user of the device when the first response indicates the availability of the resource to the similar type devices, and
a resource supplier of the resource when the second response indicates the unavailability of the resource to the second set of devices.

8. The system of claim 7, wherein the similar type devices are identified based on a consumption of an identical resource of the plurality of resources.

9. The system of claim 7 further comprises receiving a message, from the resource supplier, by the at least one user of the device, wherein the message comprises cause of the unavailability of the resource and time to resolve.

10. The system of claim 7, wherein the first set of devices, present in the premises, is communicatively coupled to a device manager, and wherein the second set of devices is communicatively coupled to a peer device manager, and wherein the device manager and the peer device manager are configured to manage operations of the first set of devices and the second set of devices respectively.

11. The system of claim 7, wherein the device comprises a sensor, a data aggregator, Internet of Thing (IoT) based devices, IoT based sensors and a Network Interface Card (NIC).

12. The system of claim 10, further comprising computing a confidence index for at least one device manager based on the unavailability of the resource to one or more of the similar type devices and a total number of the similar type devices, wherein the confidence index indicates a probability score corresponding to the unavailability of the resource.

13. A non-transitory, computer readable medium embodying a program executable in a computing device for generating an alert associated with a device consuming a resource of a plurality of resources, the program comprising a program code configured to:
receive an alert from the device of a first set of devices, present in a premises, wherein the alert is associated with an event regarding at least one of the device and the resource of the plurality of resources;
identify similar type devices from the first set of devices;
receive a first response from the similar type devices, the first response indicating whether the resource is available to the similar type devices;
receive a second response from a second set of devices, present in another premises, the second response indicating an unavailability of the resource when the first response indicates an unavailability of the resource to the similar type devices;
generate an alert to:
at least one user of the device when the first response indicates the availability of the resource to the similar type devices, and
a resource supplier of the resource when the second response indicates the unavailability of the resource to the second set of devices.
